(19) United States
(12) Patent Application Publication
(10) Pub. No.: US 2007/0288752 A1
(43) Pub. Date: Dec. 13, 2007

(54) Secure removable memory element for mobile electronic device

(76) Inventor: Weng Chong Chan, Tigard, OR (US)

Correspondence Address: SHARP LABORATORIES OF AMERICA, INC., 1320 PEARL ST., SUITE 228, BOULDER, CO, 80302, US

(21) Appl. No.: 11/449,347

(22) Filed: Jun. 8, 2006

(51) Int. Cl. H04L 9/00

(52) U.S. Cl. 713/171; 713/153

(57) ABSTRACT

Security for data stored on a removable memory element communicatively coupled with a mobile electronic device is achieved through encryption of the data using authentication information stored on a removable identification element communicatively coupled with the device. By encrypting the data stored on the removable memory element using authentication information that is stored on a removable identification element, only the possessor of the removable identification element or a person with knowledge of personal information stored thereon can access the data. Private data stored on the removable memory element is thereby advantageously protected against disclosure to a person who is not meant to have access to the data.

### BACKGROUND OF INVENTION

This invention relates to security of mobile electronic devices, and more particularly to securing data stored on a removable memory element for a mobile electronic device.

Many modern mobile electronic devices, such as mobile phones, are equipped with a slot adapted to receive a memory element, such as a memory card or memory stick, that is readily attachable and detachable from the device. These removable memory elements are often used to portably store data recorded by the mobile electronic device, such as text messages, digital photographs and voice recordings, that are intended by the user who recorded the data to be kept private.

Meanwhile, many modern mobile electronic devices are also equipped with another slot adapted to receive an identification element, such as a smart card, that is readily attachable and detachable from the device. These removable identification elements typically have stored thereon a preconfigured unique identifier, such as an international mobile subscriber identity (IMSI) and a personal identifier, such as a personal identity number (PIN), and may optionally have stored thereon a dynamically configured unique identifier, such as an over-the-air (OTA) key, one or more of which are used to authenticate the user of the mobile electronic device. That is, upon insertion of the identification element into the mobile electronic device, one or more of these pieces of authentication information is verified by an appropriate authority after which the user is allowed access to the functions and features of the mobile electronic device and select telecommunications networks and services for which the user is authorized. In the case of PIN verification, the user must input a matching PIN on a user interface of the mobile electronic device.

While removable identification elements have largely succeeded in preventing access to telecommunications networks and services for which a user of a mobile electronic device is not authorized, they are not known to have been applied to prevent access to data stored on removable memory elements for mobile electronic devices that is meant to be kept private. If a removable memory element having private data stored thereon comes into the possession of a person who is not meant to have access to the data, the person can typically access the private data by plugging the memory element into any compatible device. The fact that the compatible device may require authentication is insufficient to secure the private data since the person may be authorized to use the compatible device from which he or she accesses the private data, yet still not meant to have access to the private data.

### SUMMARY OF THE INVENTION

The invention, in a basic feature, secures data stored on a removable memory element for a mobile electronic device through encryption of the data using authentication information stored on a removable identification element for the device. By encrypting the data stored on the removable memory element using authentication information that is stored on a removable identification element, only the possessor of the removable identification element or a person with knowledge of personal information stored thereon can access the data. Private data stored on the removable memory element is thereby advantageously protected against disclosure to a person who is not meant to have access to the data.

In one aspect, a method for securing data on a removable memory element communicatively coupled with a mobile electronic device comprises receiving data on the mobile electronic device; encrypting the data using an encryption key generated using authentication information stored on a removable identification element communicatively coupled with the mobile electronic device; and storing the encrypted data on the removable memory element. The authentication information may include one or more of a preconfigured unique identifier, a dynamically configured unique identifier and a personal identifier. The dynamically configured unique identifier may be received from a remote server. The method may further comprise receiving on the mobile electronic device first access control information identifying authentication parameters for use in generating the encryption key. The access control information may identify one of unique identifier only, personal identifier only and unique identifier plus personal identifier. The method may further comprise storing on the removable memory element second access control information identifying the authentication parameters and associating the second access control information with the encrypted data.

In another aspect, a method for rendering secure data stored on a removable memory element communicatively coupled with a mobile electronic device comprises retrieving encrypted data from the removable memory element; decrypting the data using a decryption key generated using authentication information stored on a removable identification element communicatively coupled with the mobile electronic device; and rendering the decrypted data on an output of the mobile electronic device. The authentication information may include one or more of a preconfigured unique identifier, a dynamically configured unique identifier and a personal identifier. The method for rendering secure data may further comprise retrieving access control information associated with the encrypted data identifying authentication parameters for use in generating the decryption key and using the access control information to retrieve the authentication information.

In another aspect, a mobile electronic device comprises a first data receiving element, a removable identification element, a removable memory element and a processor communicatively coupled with the first data receiving element, the removable identification element and the removable memory element and adopted to receive data from the first data receiving element, encrypt the data using an encryption key generated using authentication information stored on the removable identification element and store the encrypted data on the removable memory element. The data receiving element may comprise a user interface or a network interface. The authentication information may include one or more of a preconfigured unique identifier, a dynamically configured unique identifier and a personal identifier. The processor may be further communicatively coupled with a second data receiving element and adapted to receive from the second data receiving element first access control information identifying authentication parameters for use in generating the encryption key. The first access control information may identify one of unique identifier only, personal identifier only, or unique identifier plus personal identifier. The processor may be further adapted to store on the removable memory element the encrypted data and second access control information identifying the authentication parameters and associate the encrypted data and the second access control information.

These and other aspects of the invention will be better understood by reference to the following detailed description taken in conjunction with the drawings that are briefly described below. Of course, the scope of the invention is defined by the appended claims.

### BRIEF DESCRIPTION OF THE DRAWINGS

FIG. 1 shows a mobile electronic device in one embodiment of the invention.

FIG. 2 shows a main memory of a mobile electronic device in one embodiment of the invention and device software and settings stored thereon.

FIG. 3 shows an exemplary user screen for selecting a removable memory element (RME) access control method in one embodiment of the invention.

FIG. 4 is a flow diagram of a method for securing and saving data on a RME in one embodiment of the invention.

FIG. 5 is a flow diagram of a method for rendering secure data retrieved from a RME in one embodiment of the invention.

### DETAILED DESCRIPTION OF A PREFERRED EMBODIMENT

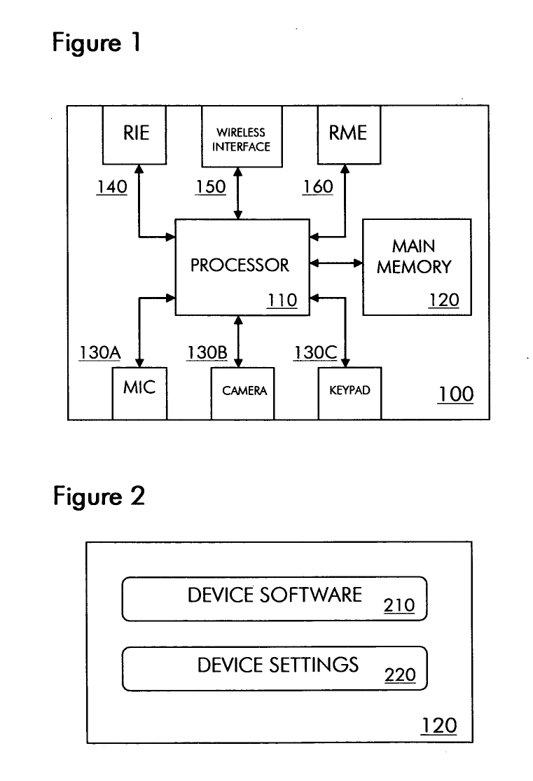

A mobile electronic device 100 in one embodiment of the invention is shown in FIG. 1. Device 100 may be, for example, a cellular phone, an Internet Protocol (IP) phone or a personal data assistant (PDA). Device 100 includes a processor 110 communicatively coupled between a plurality of data receiving elements 130A, 130B, 130C, 150, a removable identification element (RIE) 140 and a removable memory element (RME) 160. Processor 110 is adopted to execute device software stored in main memory 120 and interoperate with elements 130A, 130B, 130C, 140, 150 and 160 to perform various features and functions supported by device 100.

Data receiving elements 130A, 130B, 130C are of a type having user interfaces and include a microphone 130A adapted to receive voice inputs, a digital camera 130B adapted to receive images and a keypad 130C adapted to receive text inputs. Keypad 130C may include alpha-numeric keys, soft keys and a touch-sensitive navigation tool, for example. Naturally, other embodiments there may include additional or different data receiving elements of the type that have user interfaces.

RIE 140 is an element that is readily attachable and detachable from device 100 and is adapted to facilitate authentication of a user of device 100. Device 100 has a slot with a communication interface adapted to receive and communicatively couple with RIE 140. RIE 140 has authentication information stored thereon including one or more unique identifiers and, in some embodiments, one or more personal identifiers. In some embodiments, RIE 140 is a smart card, such as a subscriber identity module (SIM) card. In those embodiments, the one or more unique identifiers include a preconfigured unique identifier, such as an international mobile subscriber identity (IMSI) and may include a dynamically configured unique identifier, such as an over-the-air (OTA) key. The IMSI key is hard-coded on the SIM card whereas the OTA key may be acquired over wireless network interface 150 from a remote server. Moreover, in some embodiments, one or more personal identifiers stored on RIE 140 include a personal identity number (PIN). Authentication information stored on RIE 140 is used to verify the identity of a user of device 100 before the user is granted access to features and functions of device 100 and one or more subscriber networks via wireless network interface 150. For example, in some embodiments information from an IMSI or an OTA key stored on RIE 140 is transmitted via wireless network interface 150 to a subscriber network to verify the identity of a user of device 100. Additional verification may be made in such embodiments by requiring the user to input a PIN on keypad 130C that matches the PIN stored on RIE 140. Through dual IMSI (or OTA key) and PIN verification, only a user who both physically possesses RIE 140 and knows a secret code of the rightful possessor of RIE 140 is afforded access to device 100 and subscriber networks.

RME 160 is an element that is readily attachable and detachable from device 100 and is adapted to store in digital form, under control of processor 110, data received on device 100, such as voice inputs received on microphone 130A, images received on digital camera 130B, text inputs received on keypad 130C and various types of digital media received from a network on wireless network interface 150. Device 100 has a slot with a communication interface adopted to receive and communicatively couple with RME 160. RME 160 may be, for example, a memory card or a memory stick.

Turning to FIG. 2, main memory 120 is shown in more detail to include device software 210 and device settings 220. In some embodiments, main memory is a flash memory. Device software 210 includes an operating system having instructions adapted for execution by processor 110 to perform various features and functions supported by device 100. Device software 210 also includes one or more software programs having instructions adapted for execution by processor 110 to facilitate storage of data securely on RME 160, including encrypting the data using authentication information stored on RIE 140, and to facilitate rendering of secure data retrieved from RME 160 to an authorized user, including decrypting such data. Device settings 220 include a multiple of settings referenceable by processor 110 that affect, for example, how device 100 interfaces with the user. Purely by way of example, different device settings may affect access control method, language presentation, text presentation, volume, ring tone and screen saver type. Of particular interest to the present discussion is a device setting for RME access control that, in one embodiment, assumes one of four values corresponding to four distinct RME access control methods supported on device 100 and is invoked by processor 110 as now discussed.

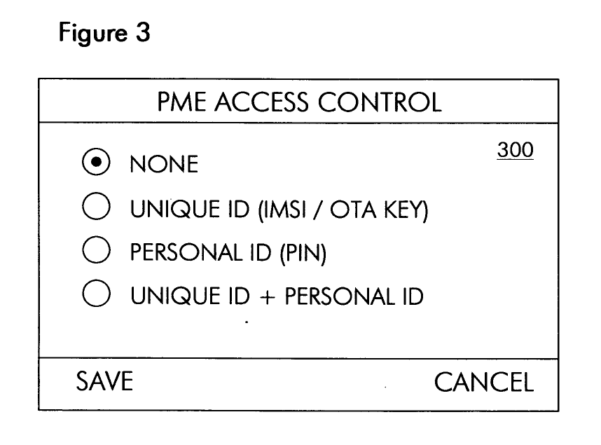

Turning now to FIG. 3, an exemplary RME access control user screen 300 in one embodiment of the invention is shown. Screen 300 is presented to a user on a display of device 100, such as a liquid crystal display (LCD), after the user makes a sequence of menu selections using keypad 130C to enable entry of access control information identifying authentication parameters for use in generating the encryption key. Screen 300 in the example shown includes four radio buttons corresponding to four different access control methods. Each access control method identifies authentication parameters for use in generating an encryption key for use in encrypting data recorded on RME 160. The user toggles between the four radio buttons using, for example, a touch-sensitive navigation tool on keypad 130C. Once the radio button next to the desired access control method has been selected, the user depresses a soft key on keypad 130C adjacent “SAVE” to render the new selection operative. The user depresses a soft key on keypad 130C adjacent “CANCEL” to return to a previous screen without rendering a new selection operative.

In one embodiment, device 100 supports four RME access control methods corresponding to the four radio buttons shown on screen 300 by way of example. A first access control method is NONE. When the NONE access control method is operative, data stored on RME 160 are not encrypted. These data are accordingly insecure and may be accessed by any user having access to RME 160 and a compatible mobile electronic device. A second access control method is UNIQUE ID. When the UNIQUE ID access control method is operative, data stored on RME 160 are encrypted using either the IMSI or OTA key stored on RIE 140. These data may accordingly be accessed only by a user of device 100 who possesses RIE 140. It will be appreciated that using an OTA key instead of an IMSI to encrypt data has an advantage in that, if a SIM card having an IMSI and OTA key is lost, the OTA key may be recovered from a remote server whereas the IMSI is not readily recoverable. A third access control method is PERSONAL ID. When the PERSONAL ID access control method is operative, data stored on RME 160 are encrypted using the PIN stored on RIE 140. These data may accordingly be accessed only by a user knowing the PIN. Finally, a fourth access control method is UNIQUE ID PLUS PERSONAL ID. When the UNIQUE ID PLUS PERSONAL ID access control method is operative, data stored on RME 160 are encrypted using one of the IMSI and OTA key stored on RIE 140 in addition to the PIN stored on RIE 140. These data may therefore be retrieved only by a user who both possesses RIE 140 and knows the PIN stored on RIE 140.

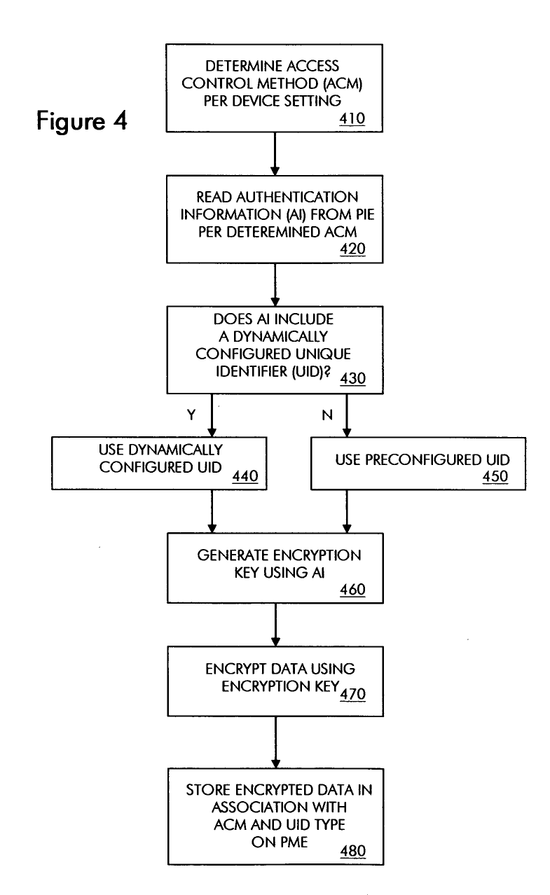

Turning now to FIG. 4, a flow diagram of a method for securing and saving data on RME 160 is shown in one embodiment of the invention. Data for recording on RME 160 are received on one or more of data receiving elements 130A, 130B, 130C, 150 The data may be, for example, one or more of speech received by microphone 130A, a digital image taken by digital camera 130B, text received on keypad 130C, or digital media received on wireless network interface 150. Processor 110 receives the data for recording and determines a RME access control method from device settings 220 (410). Processor 110 references a current value of the RME access control device setting in main memory 120 to facilitate this determination. The RME access control device setting value in some embodiments is a two-bit value that uniquely represents one of the NONE, UNIQUE ID, PERSONAL ID and UNIQUE ID PLUS PERSONAL ID access control methods.

Processor 110 then reads from RIE 140 authentication information corresponding to the determined access control method (420). Where the access control method is UNIQUE ID, the authentication information includes either a preconfigured unique identifier, such as an IMSI, a dynamically configured identifier, such as an OTA key, or both. Where the access control method is PERSONAL ID, the authentication information includes a personal identifier, such as a PIN. Where the access control method is UNIQUE ID PLUS PERSONAL ID, the authentication information includes both a personal identifier and one or more of a preconfigured unique identifier and a dynamically configured identifier. Where the access control method is NONE, no authentication information is read, the data for recording are stored as plain data and the flow terminates.

Processor 110 next determines whether the unique identifiers include a dynamically configured unique identifier, such as an OTA key (430). If so, processor 110 selects the dynamically configured unique identifier for use in the subsequent encryption step (440). If not, processor selects the preconfigured unique identifier, such as an IMSI, for use in the subsequent encryption step (450). Where the access control method is PERSONAL ID, this step is bypassed.

Processor 110 next generates an encryption key using the authentication information (460). The encryption key is a bit sequence applied as an input to an encryption/decryption algorithm of device software 210 that varies the cipher data output by the algorithm when converting data received on the one or more of data receiving elements 130A, 130B, 130, 150 from plain data that is readable by device 100 to cipher data that is unreadable by device 100 in the absence of a corresponding decryption key. The encryption/decryption algorithm may selected from among many well-known ciphers, such as Twofish, Serpent, AES, Blowfish, CAST5, RC4, 3DES and IDEA, for example. In some embodiments, a user of device 100 may choose an encryption/decryption algorithm from among multiple such algorithms supported on device 100. Where the access control method is UNIQUE ID, the encryption key is generated as a function of the particular unique identifier, such as the IMSI or OTA key, selected in Steps 430-450. Where the access control method is PERSONAL ID, the encryption key is generated as a function of the personal identifier, such as the PIN, read from RIE 140. Where the access control method is UNIQUE ID PLUS PERSONAL ID, the encryption key is generated as a function of both the unique identifier selected in Steps 430 through 450 and the personal identifier read from RIE 140. In some embodiments, the whole identifier (or identifiers) is (are) used to generate the encryption key. In other embodiments, a portion of the identifier (or identifiers) is (are) used to generate the encryption key. In some embodiments, the encryption key includes bits constituting the identifier (or identifiers), whereas in other embodiments the encryption key includes bits derived from the identifier (or identifiers). Processor 10 next encrypts the data for recording using the encryption key generated in Step 460 (470).

Finally, processor 110 stores the encrypted data on RME 160 and associates with the encrypted data access control information identifying authentication parameters including the RME access control method and the unique identifier type selected in Steps 430 through 450 (480). The access control information in some embodiments is appended as a header to a file that contains the encrypted data. The header in some embodiments also includes unused fields that are reserved for future use. In other embodiments, the access control information is stored in a separate file on RME 160 and the association with the encrypted data is maintained by conventional means. The access control method authentication parameter in some embodiments is a two-bit value uniquely representing one of the NONE, UNIQUE ID, PERSONAL ID and UNIQUE ID PLUS PERSONAL ID access control methods. The same two-bit values may be used as are used in the RME access method device setting. The unique identifier type authentication parameter in some embodiments is a one-bit value uniquely representing either a preconfigured unique identifier type (e.g. IMSI) or a dynamically configured unique identifier type (e.g. OTA key).

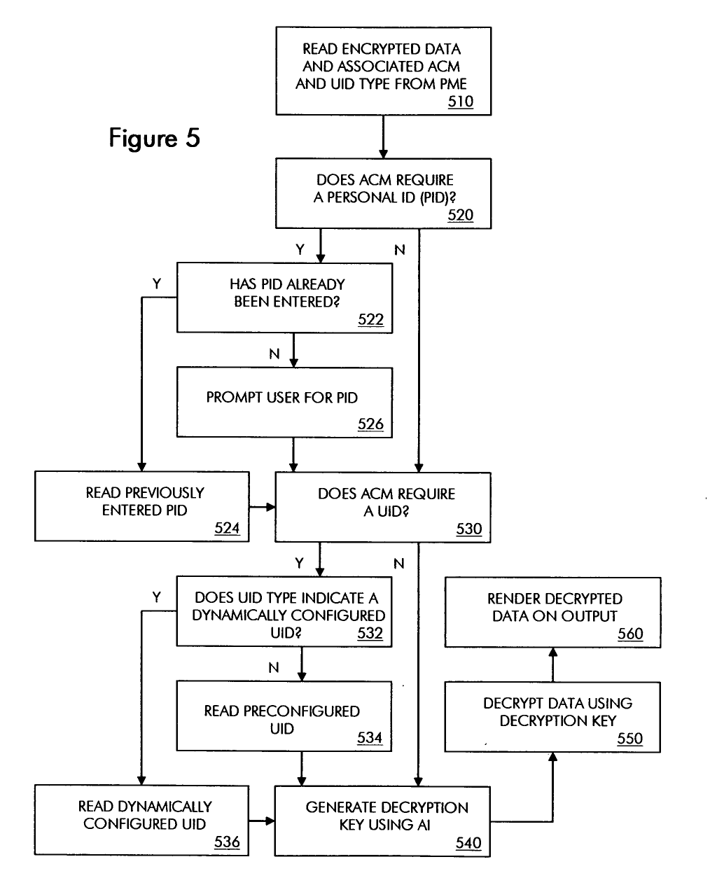

Turning now to FIG. 5, a flow diagram of a method for rendering secure data retrieved from RME 160 is shown in one embodiment of the invention. The flow is executed by processor 110 after a user of device 100 makes a sequence of menu selections using keypad 130C requesting encrypted data from RME 160. The requested data may be, for example, speech received by microphone 130A, a digital image taken by digital camera 130B, text received on keypad 130C or digital media received on wireless network interface 150 that has been previously encrypted using the method of FIG. 4 and recorded on RME 160. Note that if requested data are not encrypted, processor 110 renders the data to the user on a display without performing the method of FIG. 5.

Processor 110 reads from RME 160 the requested data and access control information identifying the RME access control method and the unique identifier type used in encrypting the data (510). As mentioned, the access control information in some embodiments is appended as a header to a file containing the encrypted data.

Processor 110 then determines whether the access control method requires a personal identifier, such as a PIN (520). The PERSONAL ID and UNIQUE ID PLUS PERSONAL ID access control methods require a personal identifier. If a personal identifier is required, processor 110 determines whether the personal identifier has already been entered by the current user of device 100 (522). If it has already been entered, processor 110 retrieves the previously entered personal identifier from RIE 140 or main memory 120 (524). If it has not already been entered, processor 110 prompts the user for the personal identifier (526). If a personal identifier is not required, processor 110 bypasses Steps 522 through 526.

Processor 110 then determines whether the access control method requires unique identifier, such as a preconfigured unique identifier or a dynamically configured unique identifier (530). The UNIQUE ID and UNIQUE ID PLUS PERSONAL ID access control methods require a unique identifier. If a unique identifier is required, processor 110 determines from the unique identifier type whether the required unique identifier is a preconfigured unique identifier, such as an IMSI, or a dynamically configured unique identifier, such as an OTA key (532). If the required unique identifier is a preconfigured unique identifier, processor 110 retrieves the preconfigured unique identifier from RIE 140 (534). If the required unique identifier is a dynamically configured unique identifier, processor 110 retrieves the dynamically configured unique identifier from RIE 140 (536). If a unique identifier is not required, processor 110 bypasses Steps 532 through 536.

Processor 110 next generates a decryption key using the authentication information, that is, the unique identifier and/or the personal identifier (540). The decryption key is a bit sequence applied as an input to an encryption/decryption algorithm of device software 210 that varies the data output by the algorithm when converting encrypted data retrieved from RME 160 from cipher data that is unreadable by device 100 to plain data that is readable by device 100. Where the access control method is UNIQUE ID, the decryption key is generated as a function of the particular unique identifier, such as the IMSI or OTA key, resulting from Steps 530 through 536. Where the access control method is PERSONAL ID, the decryption key is generated as a function of the personal identifier, such as the PIN, resulting from Steps 520 through 526. Where the access control method is UNIQUE ID PLUS PERSONAL ID, the decryption key is generated as a function of both the unique identifier resulting from Steps 530 through 536 and the personal identifier resulting from Steps 520 through 526. In some embodiments, the whole identifier (or identifiers) is (are) used to generate the decryption key. In other embodiments, a portion of the identifier (or identifiers) is (are) used to generate the decryption key. In some embodiments, the decryption key includes bits constituting the identifier (or identifiers), whereas in other embodiments the decryption key includes bits derived from the identifier (or identifiers). Processor 110 next decrypts the data using the decryption key generated in Step 540 (550) and renders the decrypted data on one or more data output elements of device 100, such as an LCD display or a speaker system (560).

It will be appreciated that since the data are stored on RME 160 in encrypted form, the data are protected from disclosure in the event RME 160 is lost, stolen, or otherwise comes into the possession of an unauthorized person, unless the unauthorized person also possesses RIE 140 and/or the personal identifier of the user who caused the data to be recorded on RME 160. Consider an example where a user of a mobile electronic device in which RME 160 is inserted requests encrypted data that has been previously stored on RME 160 using the UNIQUE ID PLUS PERSONAL ID access method. If a removable information element other than RIE 140 is inserted in the mobile electronic device, the decryption key generated using the unique identifier retrieved from the removable information element will not succeed in decrypting the data. Moreover, if the user enters the personal identifier that does not match the one entered by the user who caused the data to be recorded on RME 160, the decryption key generated using the non-matching personal identifier will not succeed in decrypting the data. Indeed, insertion of RIE 140 without entry of the matching personal identifier, or entry of the matching personal identifier without insertion of RIE 140, will not result in successful decryption of requested data that has been previously stored on RME 160 using the UNIQUE ID PLUS PERSONAL ID access method. Both are required.

On the other hand, a user who causes data to be recorded on RME 160 may choose a less rigorous security method such that only insertion of RIE 140 (e.g. UNIQUE ID access control method) or entry of the matching personal identifier (e.g. PERSONAL ID access control method) is required to decrypt the data.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A method for securing data on a removable memory element communicatively coupled with a mobile electronic device, comprising:
receiving data on the mobile electronic device;
encrypting the data using an encryption key generated using authentication information stored on a removable identification element communicatively coupled with the mobile electronic device; and
storing the encrypted data on the removable memory element.

2. The method of claim 1 further comprising receiving on the mobile electronic device first access control information identifying one or more authentication parameters for use in generating the encryption key.

3. The method of claim 2 further comprising storing on the removable memory element second access control information identifying the authentication parameters and associating the stored second access control information with the encrypted data.

4. The method of claim 1 wherein the removable identification element comprises a smart card.

5. The method of claim 1 wherein the authentication information comprises one or more of a unique identifier and a personal identifier.

6. The method of claim 5 wherein the unique identifier is preconfigured.

7. The method of claim 5 wherein the unique identifier is dynamically configured.

8. The method of claim 7 wherein the unique identifier is acquired from a remote server.

9. A method for rendering secure data stored on a removable memory element communicatively coupled with a mobile electronic device, comprising:
retrieving encrypted data from the removable memory element;
decrypting the data using a decryption key generated using authentication information stored on a removable identification element communicatively coupled with the mobile electronic device; and
rendering the decrypted data on an output of the mobile electronic device.

10. The method of claim 9 further comprising retrieving from the removable memory element access control information identifying one or more authentication parameters for use in generating the decryption key.

11. The method of claim 10 wherein the access control information is stored on the removable memory element and associated with the encrypted data.

12. The method of claim 9 wherein the removable identification element comprises a smart card.

13. The method of claim 9 wherein the authentication information comprises a unique identifier.

14. The method of claim 9 wherein the decryption key is further generated using a personal identifier entered on the mobile electronic device.

15. A mobile electronic device, comprising:
a first data receiving element;
a removable identification element;
a removable memory element; and
a processor communicatively coupled with the first data receiving element, the removable identification element and the removable memory element and adapted to receive data from the first data receiving element, encrypt the data using an encryption key generated using authentication information stored on the removable identification element and store the encrypted data on the removable memory element.

16. The device of claim 15 wherein the device further comprises a second data receiving element communicatively coupled with the processor and adapted to receive first access control information identifying one or more authentication parameters for use in generating the encryption key.

17. The method of claim 16 wherein second access control information identifying the authentication parameters are stored on the removable memory element and associated with the encrypted data.

18. The method of claim 15 wherein the removable identification element comprises a smart card.

19. The method of claim 15, wherein the first data receiving element is selected from the group consisting of a microphone, a digital camera, a keypad and a wireless network interface.

20. The method of claim 16, wherein the second data receiving element is a keypad.
